(19) United States
(12) Patent Application Publication
(10) Pub. No.: US 2012/0166218 A1
(43) Pub. Date: Jun. 28, 2012

(54) METHOD AND SYSTEM OF REAL-TIME CUSTOMIZABLE MEDICAL SEARCH ANALYTICS

(76) Inventor: Bruce REINER, Berlin, MD (US)

(21) Appl. No.: 13/338,037

(22) Filed: Dec. 27, 2011

Related U.S. Application Data
(60) Provisional application No. 61/457,103, filed on Dec. 27, 2010.

(51) Int. Cl. G06Q 50/22

(52) U.S. Cl. 705/2

(57) ABSTRACT

The present invention relates to the creation of a program which institutes a series of standardized objective metrics for customizable comparative analysis, in keeping with the individual priorities and preferences of the individual consumer. The derived analytics can in turn be tracked and analyzed by the program in order to determine use, satisfaction, and outcomes (i.e., performance); as they relate to both consumers and providers of both services and products of interest. While the present invention can be applied to essentially any service or product-related industry; the primary focus of discussion will relate to medicine; pertaining to both medical service delivery, as well as the various medical products (e.g., pharmaceuticals, medical devices) in use.

### CROSS-REFERENCE TO RELATED APPLICATIONS

This application claims priority from U.S. Provisional Patent Application No. 61/457,103, filed on Dec. 27, 2010, the contents of which are herein incorporated by reference in their entirety.

### BACKGROUND OF THE INVENTION

1. Field of the Invention

The present invention relates to the creation of the requisite data and technology infrastructure required for applying the same principles of consumer empowerment, to the service industry. The present invention creates a program which institutes a series of standardized objective metrics for customizable comparative analysis, in keeping with the individual priorities and preferences of the individual consumer. The derived analytics can in turn be tracked and analyzed by the program in order to determine use, satisfaction, and outcomes (i.e., performance), as they relate to both consumers and providers of both services and products of interest. While the present invention can be applied to essentially any service or product-related industry, the primary focus of the present invention relates to medicine, pertaining to both medical service delivery, as well as the various medical products (e.g., pharmaceuticals, medical devices) in use.

2. Description of the Related Art

New technology development in e-commerce has transformed the manner in which consumers shop for commodities. Not long ago, a customer wishing to purchase a television set would physically travel to a retail store, review available options, interact with a salesperson, and make a selection based upon their individual preference, product availability, and cost.

Using new technology, like smart phones, consumers can now perform real-time, qualitative and quantitative comparative analysis on the various products of interest. This has redefined commercial sales and led to a new era of consumer empowerment. A prospective customer is no longer tied to geographic boundaries, provider sales tactics, or limitations in product availability and cost.

The principal reason why this new technology is feasible is that the products being analyzed are commodities, with a finite and well-defined number of standardized data requirements. If one was to attempt to apply the same technology to comparative analysis for the service industries, they would be limited by a number of variables including (but not limited to) the paucity of standardized data, number of confounding variables, individual bias and subjectivity, and lack of oversight by a neutral and well qualified third party.

In the current medical practice paradigm, healthcare consumers have limited options as to provider selection and analysis of service deliverables. While a patient is typically thought of as the prototypical consumer, consumer groups also include physicians, administrators, and third party payers. Examples of healthcare service deliverables and consumer groups include: a) Service Deliverables—clinical care (e.g., primary care, specialist consultation), examinations and testing (e.g., laboratory, radiology), procedures (e.g., surgery, radiation therapy), and products (e.g., pharmaceuticals, technology), b) Consumer Groups—Patients, Physicians, Administrators, and Third Party Payers, and c) Continuum of Care—prevention and screening, diagnosis, treatment, and disease surveillance. Essentially, these deliverables consist of human-human interactions (e.g., history and physical), clinical tests (e.g., mammogram), interventions (e.g., surgical procedure), and products (e.g., pharmaceuticals).

In the course of provider selection, consumers commonly rely on “word of mouth” referrals or recommendations. Referrals typically are derived from one healthcare provider (e.g., family practice physician) recommending another healthcare provider (e.g., surgical specialist) to a consumer (e.g., patient). Recommendations can be derived from one consumer (e.g., patient A) recommending a provider to another consumer (e.g., patient B). In either case, the “word of mouth” process of provider selection is largely based upon subjective experience and perception, which can be wrought with bias and misperception, and lack of substantiate data. The manner in which this referral or recommendation takes place, typically limits the number of presented options to the consumer, and does so with little if any objective data to assist in the selection process. The end result, is often “trial and error”, which has the potential to result in highly variable customer satisfaction, uncertainty (relating to provider selection), and limited feedback (between the recommending and receiving parties). If the consumer is dissatisfied with the services rendered, non-compliance can ensue; with the potential to delay diagnosis or treatment, increase healthcare costs (e.g., doctor shopping), and adversely affect clinical outcomes.

While often unstated, the current model of provider selection has the potential for conflict of interest on the part of the referring party. This can take the form of physician “quid pro quo” referrals, physician self-referrals (e.g., in tests providing direct or indirect financial remuneration or other form of compensation back to the referring physician), or third party payer referrals to “in network” providers. In these situations, the referrals are often generated on pre-existing business relationships with direct or indirect financial benefits to the referring party. In the absence of complete disclosure and knowledge of viable alternatives, the consumer often accepts the recommendation, without investigating alternative options.

The ideal scenario for healthcare service provider selection would be to replace the current model with one predicated upon objective data analysis. Rather than rely upon the subjective perceptions (and potential biases) of a third party, a method and system that can collect and analyze standardized data from multiple sources and present this data to a consumer for provider or product selection, in keeping with the individual attributes, priorities, and preferences of each individual consumer, is desired. Thus, a data-driven model for healthcare service provider selection, analytics, and feedback is desired.

### SUMMARY OF THE INVENTION

The present invention utilizes a series of objective and subjective data to create a program which utilizes standardized databases for the purposes of quantifying performance in the delivery of medical services. The major categories of analysis include Quality, Safety, Operational Efficiency, Customer Service, and Economics. These performance analytics can be evaluated on an individual or collective basis (i.e., Composite Score); to provide the healthcare consumer with a standardized and reproducible performance measure; relating to their own specific medical needs, subjective preferences, or priorities. The present invention provides an easy to use mechanism for weighting these variables in a customizable fashion, resulting in a context and user-specific Composite Score.

The various search analytics which can be derived from the program can be simple and straightforward (e.g., next available appointment) or extremely complex (e.g., complication rate of a specific surgical procedure in a specific patient population). These analytics can be derived through both manual and automated means, with the program recording and tracking use patterns of the consumers and combining this with the individual end-user profile to create predictive search analytics. The end goal is for the program to identify specific patterns of use, relative to the individual end-user profile, clinical context, and required service deliverables.

In addition to providing healthcare consumers with real-time and portable search capabilities relating to service performance, the present invention can also be used for education and training, healthcare research, credentialing and licensing, comparative technology assessment, trending analysis, and automated (and customized) alerts related to individual healthcare needs. The goal of the present invention is to empower all levels of healthcare consumers, by providing them with data-driven knowledge, in order to improve clinical outcomes. At the same time, the derived data analytics of the program can provide healthcare service providers with data-driven opportunities for education, training, and process improvement. In the end, an educated consumer (and service provider) will promote improved service deliverables and clinical outcomes. The present invention aims to accomplish this task by empowering healthcare providers and consumers through standardized data-driven performance analytics.

There has thus been outlined, some features that are consistent with the present invention in order that the detailed description thereof that follows may be better understood, and in order that the present contribution to the art may be better appreciated. There are, of course, additional features consistent with the present invention that will be described below and which will form the subject matter of the claims appended hereto.

In this respect, before explaining at least one embodiment consistent with the present invention in detail, it is to be understood that the invention is not limited in its application to the details of construction and to the arrangements of the components set forth in the following description or illustrated in the drawings. Methods and apparatuses consistent with the present invention are capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the methods and apparatuses consistent with the present invention.

### BRIEF DESCRIPTION OF THE DRAWINGS

FIG. 1 is a schematic diagram which shows the system of the present invention.

FIGS. 2A-2B are flowcharts show a first sequence of access to the program of the present invention, and how it is used by the user to determine performance metrics.

FIG. 3 is a flowchart showing a second sequence of access to the program of the present invention, and how it is used by the user to determine performance metrics.

### DESCRIPTION OF THE INVENTION

The present invention relates to the creation of the requisite data and technology infrastructure required for applying the same principles of consumer empowerment, to the service industry. The present invention creates a program which institutes a series of standardized objective metrics for customizable comparative analysis, in keeping with the individual priorities and preferences of the individual consumer. The derived analytics can in turn be tracked and analyzed by the program in order to determine use, satisfaction, and outcomes (i.e., performance), as they relate to both consumers and providers of both services and products of interest. While the present invention can be applied to essentially any service or product-related industry; the primary focus of the present invention relates to medicine, pertaining to both medical service delivery, as well as the various medical products (e.g., pharmaceuticals, medical devices) in use.

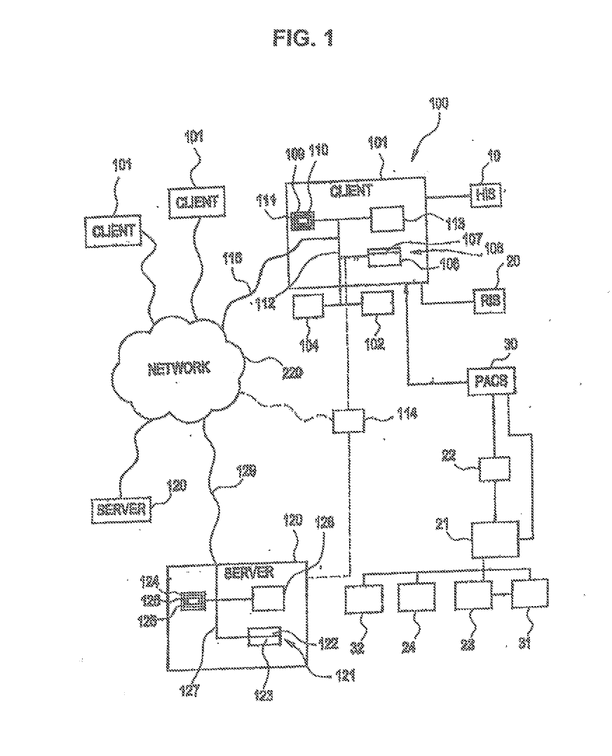

According to one embodiment of the invention illustrated in FIG. 1, medical (i.e., radiological) applications may be implemented using the system 100. The system 100 is designed to interface with existing information systems such as a Hospital Information System (HIS) 10, a Radiology Information System (RIS) 20, a radiographic device 21, and/or other information systems that may access a computed radiography (CR) cassette or direct radiography (DR) system, a CR/DR plate reader 22, a Picture Archiving and Communication System (PACS) 30, and/or other systems. The system 100 may be designed to conform with the relevant standards, such as the Digital Imaging and Communications in Medicine (DICOM) standard, DICOM Structured Reporting (SR) standard, and/or the Radiological Society of North America's Integrating the Healthcare Enterprise (IHE) initiative, among other standards.

According to one embodiment, bi-directional communication between the system 100 of the present invention and the information systems, such as the HIS 10, RIS 20, QA sensor device 21, CR/DR plate reader 22, and PACS 30, etc., may be enabled to allow the system 100 to retrieve and/or provide information from/to these systems. According to one embodiment of the invention, bi-directional communication between the system 100 of the present invention and the information systems allows the system 100 to update information that is stored on the information systems. According to one embodiment of the invention, bi-directional communication between the system 100 of the present invention and the information systems allows the system 100 to generate desired reports and/or other information.

The system 100 of the present invention includes a client computer 101, such as a personal computer (PC), which may or may not be interfaced or integrated with the PACS 30. The client computer 101 may include an imaging display device 102 that is capable of providing high resolution digital images in 2-D or 3-D, for example. According to one embodiment of the invention, the client computer 101 may be a mobile terminal if the image resolution is sufficiently high. Mobile terminals may include mobile computing devices, a mobile data organizer (PDA), or other mobile terminals that are operated by the user accessing the program 110 remotely.

According to one embodiment of the invention, an input device 104 or other selection device, may be provided to select hot clickable icons, selection buttons, and/or other selectors that may be displayed in a user interface using a menu, a dialog box, a roll-down window, or other user interface. The user interface may be displayed on the client computer 101. According to one embodiment of the invention, users may input commands to a user interface through a programmable stylus, keyboard, mouse, speech processing device, laser pointer, touch screen, or other input device 104.

According to one embodiment of the invention, the input or other selection device 104 may be implemented by a dedicated piece of hardware or its functions may be executed by code instructions that are executed on the client processor 106. For example, the input or other selection device 104 may be implemented using the imaging display device 102 to display the selection window with a stylus or keyboard for entering a selection.

According to another embodiment of the invention, symbols and/or icons may be entered and/or selected using an input device 104, such as a multi-functional programmable stylus. The multi-functional programmable stylus may be used to draw symbols onto the image and may be used to accomplish other tasks that are intrinsic to the image display, navigation, interpretation, and reporting processes, as described in U.S. patent application Ser. No. 11/512,199 filed Aug. 30, 2006, now U.S. Pat. No. 8,081,165, the entire contents of which are herein incorporated by reference. The multi-functional programmable stylus may provide superior functionality compared to traditional computer keyboard or mouse input devices. According to one embodiment of the invention, the multi-functional programmable stylus also may provide superior functionality within the PACS and Electronic Medical Report (EMR).

According to one embodiment of the invention, the client computer 101 may include a processor 106 that provides client data processing. According to one embodiment of the invention, the processor 106 may include a central processing unit (CPU) 107, a parallel processor, an input/output (I/O) interface 108, a memory 109 with a program 110 having a data structure 111, and/or other components. According to one embodiment of the invention, the components all may be connected by a bus 112.

Further, the client computer 101 may include the input device 104, the image display device 102, and one or more secondary storage devices 113. According to one embodiment of the invention, the bus 112 may be internal to the client computer 101 and may include an adapter that enables interfacing with a keyboard or other input device 104. Alternatively, the bus 112 may be located external to the client computer 101.

According to one embodiment of the invention, the image display device 102 may be a high resolution touch screen computer monitor. According to one embodiment of the invention, the image display device 102 may clearly, easily and accurately display images, such as x-rays, and/or other images. Alternatively, the image display device 102 may be implemented using other touch sensitive devices including tablet personal computers, pocket personal computers, plasma screens, among other touch sensitive devices. The touch sensitive devices may include a pressure sensitive screen that is responsive to input from the input device 104, such as a stylus, that may be used to write/draw directly onto the image display device 102.

According to another embodiment of the invention, high resolution goggles may be used as a graphical display to provide end users with the ability to review images. According to another embodiment of the invention, the high resolution goggles may provide graphical display without imposing physical constraints of an external computer.

According to another embodiment, the invention may be implemented by an application that resides on the client computer 101, wherein the client application may be written to run on existing computer operating systems. Users may interact with the application through a graphical user interface. The client application may be ported to other personal computer (PC) software, personal digital assistants (PDAs), cell phones, and/or any other digital device that includes a graphical user interface and appropriate storage capability.

According to one embodiment of the invention, the processor 106 may be internal or external to the client computer 101. According to one embodiment of the invention, the processor 106 may execute a program 110 that is configured to perform predetermined operations. According to one embodiment of the invention, the processor 106 may access the memory 109 in which may be stored at least one sequence of code instructions that may include the program 110 and the data structure 111 for performing predetermined operations. The memory 109 and the program 110 may be located within the client computer 101 or external thereto.

While the system of the present invention may be described as performing certain functions, one of ordinary skill in the art will readily understand that the program 110 may perform the function rather than the entity of the system itself.

According to one embodiment of the invention, the program 110 that runs the system 100 may include separate programs 110 having code that performs desired operations. According to one embodiment of the invention, the program 110 that runs the system 100 may include a plurality of modules that perform sub-operations of an operation, or may be part of a single module of a larger program 110 that provides the operation.

According to one embodiment of the invention, the processor 106 may be adapted to access and/or execute a plurality of programs 110 that correspond to a plurality of operations. Operations rendered by the program 110 may include, for example, supporting the user interface, providing communication capabilities, performing data mining functions, performing e-mail operations, and/or performing other operations.

According to one embodiment of the invention, the data structure 111 may include a plurality of entries. According to one embodiment of the invention, each entry may include at least a first storage area, or header, that stores the databases or libraries of the image files, for example.

According to one embodiment of the invention, the storage device 113 may store at least one data file, such as image files, text files, data files, audio files, video files, among other file types. According to one embodiment of the invention, the data storage device 113 may include a database, such as a centralized database and/or a distributed database that are connected via a network. According to one embodiment of the invention, the databases may be computer searchable databases. According to one embodiment of the invention, the databases may be relational databases. The data storage device 113 may be coupled to the server 120 and/or the client computer 101, either directly or indirectly through a communication network, such as a LAN, WAN, and/or other networks. The data storage device 113 may be an internal storage device. According to one embodiment of the invention, the system 100 may include an external storage device 114. According to one embodiment of the invention, data may be received via a network and directly processed.

According to one embodiment of the invention, the client computer 101 may be coupled to other client computers 101 or servers 120. According to one embodiment of the invention, the client computer 101 may access administration systems, billing systems and/or other systems, via a communication link 116. According to one embodiment of the invention, the communication link 116 may include a wired and/or wireless communication link, a switched circuit communication link, or may include a network of data processing devices such as a LAN, WAN, the Internet, or combinations thereof. According to one embodiment of the invention, the communication link 116 may couple e-mail systems, fax systems, telephone systems, wireless communications systems such as pagers and cell phones, wireless PDA's and other communication systems.

According to one embodiment of the invention, the communication link 116 may be an adapter unit that is capable of executing various communication protocols in order to establish and maintain communication with the server 120, for example. According to one embodiment of the invention, the communication link 116 may be implemented using a specialized piece of hardware or may be implemented using a general CPU that executes instructions from program 110. According to one embodiment of the invention, the communication link 116 may be at least partially included in the processor 106 that executes instructions from program 110.

According to one embodiment of the invention, if the server 120 is provided in a centralized environment, the server 120 may include a processor 121 having a CPU 122 or parallel processor, which may be a server data processing device and an I/O interface 123. Alternatively, a distributed CPU 122 may be provided that includes a plurality of individual processors 121, which may be located on one or more machines. According to one embodiment of the invention, the processor 121 may be a general data processing unit and may include a data processing unit with large resources (i.e., high processing capabilities and a large memory for storing large amounts of data).

According to one embodiment of the invention, the server 120 also may include a memory 124 having a program 125 that includes a data structure 126, wherein the memory 124 and the associated components all may be connected through bus 127. If the server 120 is implemented by a distributed system, the bus 127 or similar connection line may be implemented using external connections. The server processor 121 may have access to a storage device 128 for storing preferably large numbers of programs 110 for providing various operations to the users.

According to one embodiment of the invention, the data structure 126 may include a plurality of entries, wherein the entries include at least a first storage area that stores image files. Alternatively, the data structure 126 may include entries that are associated with other stored information as one of ordinary skill in the art would appreciate.

According to one embodiment of the invention, the server 120 may include a single unit or may include a distributed system having a plurality of servers 120 or data processing units. The server(s) 120 may be shared by multiple users in direct or indirect connection to each other. The server(s) 120 may be coupled to a communication link 129 that is preferably adapted to communicate with a plurality of client computers 101.

According to one embodiment, the present invention may be implemented using software applications that reside in a client and/or server environment. According to another embodiment, the present invention may be implemented using software applications that reside in a distributed system over a computerized network and across a number of client computer systems. Thus, in the present invention, a particular operation may be performed either at the client computer 101, the server 120, or both.

According to one embodiment of the invention, in a client-server environment, at least one client and at least one server are each coupled to a network 220, such as a Local Area Network (LAN), Wide Area Network (WAN), and/or the Internet, over a communication link 116, 129. Further, even though the systems corresponding to the HIS 10, the RIS 20, the radiographic device 21, the CR/DR reader 22, and the PACS 30 (if separate) are shown as directly coupled to the client computer 101, it is known that these systems may be indirectly coupled to the client over a LAN, WAN, the Internet, and/or other network via communication links. According to one embodiment of the invention, users may access the various information sources through secure and/or non-secure internet connectivity. Thus, operations consistent with the present invention may be carried out at the client computer 101, at the server 120, or both. The server 120, if used, may be accessible by the client computer 101 over the Internet, for example, using a browser application or other interface.

According to one embodiment of the invention, the client computer 101 may enable communications via a wireless service connection. The server 120 may include communications with network/security features, via a wireless server, which connects to, for example, voice recognition. According to one embodiment, user interfaces may be provided that support several interfaces including display screens, voice recognition systems, speakers, microphones, input buttons, and/or other interfaces. According to one embodiment of the invention, select functions may be implemented through the client computer 101 by positioning the input device 104 over selected icons. According to another embodiment of the invention, select functions may be implemented through the client computer 101 using a voice recognition system to enable hands-free operation. One of ordinary skill in the art will recognize that other user interfaces may be provided.

According to another embodiment of the invention, the client computer 101 may be a basic system and the server 120 may include all of the components that are necessary to support the software platform. Further, the present client-server system may be arranged such that the client computer 101 may operate independently of the server 120, but the server 120 may be optionally connected. In the former situation, additional modules may be connected to the client computer 101. In another embodiment consistent with the present invention, the client computer 101 and server 120 may be disposed in one system, rather being separated into two systems.

Although the above physical architecture has been described as client-side or server-side components, one of ordinary skill in the art will appreciate that the components of the physical architecture may be located in either client or server, or in a distributed environment.

Further, although the above-described features and processing operations may be realized by dedicated hardware, or may be realized as programs having code instructions that are executed on data processing units, it is further possible that parts of the above sequence of operations may be carried out in hardware, whereas other of the above processing operations may be carried out using software.

The underlying technology allows for replication to various other sites. Each new site may maintain communication with its neighbors so that in the event of a catastrophic failure, one or more servers 120 may continue to keep the applications running, and allow the system to load-balance the application geographically as required.

Further, although aspects of one implementation of the invention are described as being stored in memory, one of ordinary skill in the art will appreciate that all or part of the invention may be stored on or read from other computer-readable media, such as secondary storage devices, like hard disks, floppy disks, CD-ROM, or other forms of ROM or RAM either currently known or later developed. Further, although specific components of the system have been described, one skilled in the art will appreciate that the system suitable for use with the methods and systems of the present invention may contain additional or different components.

As a preliminary matter, the creation of objective databases for assessment of medical quality and safety has been previously described in related patent applications related to Quality Assurance (U.S. patent application Ser. No. 11/412,884, filed Apr. 28, 2006), Radiation Safety (U.S. patent application Ser. No. 11/976,518, filed Oct. 25, 2007), Medical Imaging Agent (U.S. patent application Ser. No. 12/010,707, filed Jan. 29, 2008, now U.S. Pat. No. 7,933,782), and Pharmaceutical Scorecards (U.S. patent application Ser. No. 13/200,545, filed Sep. 26, 2011), the contents of all of which are herein incorporated by reference in their entirety. These serve as a model for the collection, storage, analysis, and dissemination of standardized metrics used for analyzing healthcare performance deliverables.

The primary categories of healthcare service analysis include: A) Primary Service Analyses—operational efficiency (e.g., timeliness), quality (e.g., clinical outcomes), cost-efficacy (e.g., comparative cost), customer service/satisfaction (e.g., subjectively perceived value of the specific product and/or service being utilized), and safety (e.g., iatrogenic complications); B) Secondary Provider Analyses—geographic location, demographics, availability, pedigree (experience and training), technology, and economic profile. With the exception of Customer Service/Satisfaction, these analyses are all predicated upon objective data. The derived categorical analyses by the program 110 of the present invention, are longitudinal in nature and as a result are continuously changing, as new data is recorded by the program 110 in the database 113, 114 and incorporated into the derived analytics.

While the primary service analyses are meant to assess high level provider (or product) performance (e.g., quality or safety metrics), the secondary analyses are focused on more practical and customizable measures such as geographic location, demographics, availability, economic profile, and pedigree. In all circumstances, the prioritization of these categorical analyses can be customized by the program 110 to the specific needs and preferences of each individual healthcare consumer and the specific context of the requested service or product (i.e., context and user-specific prioritization schema). This also serves as a unique and differentiating feature of the present invention, in that analyses derived from the standardized database 113, 114 can be customized to the specific needs and preferences of individual consumers or generalizable to multi-party (both small and large) consumer groups. The derived analytics provide a standardized mechanism for evaluating and comparing performance measures among medical service and product providers; and can be performed on an individual, group, institutional, or network level.

The dynamic and longitudinal nature of the data analysis provides an important and distinguishing feature of the present invention, in the form of trending analysis. An individual reviewing the data can not only review comparative analysis of each service provider at a single point in time (i.e., static data), but also review how that provider's (or product's) performance has changed over a defined time interval. In a dynamic field such as medicine, this is particularly important, as standards in practice, treatment options, product/service refinements, and technologies are constantly changing.

In order to ensure integrity and accuracy of the data being recorded, all data input sources undergo authentication/identification using biometrics (see related Biometrics U.S. Pat. No. 7,593,549, which is hereby incorporated by reference in its entirety). This is particularly important for Customer Service/Satisfaction data; due to the fact that it is subjective (and not directly verifiable by alternative and objective data sources).

Once the referenceable databases 113, 114 are in place and operational, an authorized end-user can access the system using an Internet browser to generate a manual search, of varying complexity. An example of a simple, straightforward search conducted by the program 110 could include a patient wishing to schedule a procedure of test or as complex as a physician searching for quality/safety performance measures of sub-specialists performing a complex surgical procedure. In all cases, the end-user has the ability to customize the search with as few or many search criteria and input variables as desired.

An example of a simple search application can be seen with a patient who is instructed by his/her primary care physician to obtain a blood test to evaluate liver enzymes (prior to initiation of a pharmaceutical which has the potential to cause liver damage). In this particular case, the patient is only interested in identifying nearby service providers who can perform the test as soon as possible. In this example, the sole search criteria are Geographic Location and Availability. Once the starting location and requested test are inputted by the user, the program 110 will search the database 113, 114 and provide the end-user with a list of qualified service providers within the defined geographic radius of interest, along with available appointment times (arranged in chronological order).

The patient can then select the provider of choice, request scheduling, and have a verified appointment receipt confirmation electronically sent by the program 110, within seconds. The ability to directly link service providers to the database 113, 114 creates an effective mechanism to communicate, schedule, order, and generate consultations between service/product providers and their respective consumers. In the event that a service or product provider was not directly integrated to the database 113, 114, an electronic query could be generated by the program 110 with a request for follow-up in accordance with the specific needs and time frame of the consumer. In this manner, the consumer could perform both analytical searches and queries, as well as scheduling and ordering, using a single platform (i.e., program 110).

The response times and consumer satisfaction with respect to these queries could also become an integral part of the database 113, 114. In this way, consumers could gauge the degree to which service and/or product providers respond to consumer queries and utilize this data to further serve as a guide for continued and future use. In the event that a consumer-generated query went unanswered by a provider, or was delayed by the provider, the provider could have an automated prompt/alert sent by the program 110 to their compliance department for appropriate follow-up. This creates an all-inclusive tool to measure consumer satisfaction, ensure timeliness and accuracy of response, and serve as an internal barometer of service. This highlights another feature of the present invention—the fact that the data recorded, tracked, and analyzed is multi-directional and multi-purpose in nature.

In addition to manual data input, automated data capture by the program 110 can eliminate several of these steps (geographic location and desired test). In the automated mode of operation, the global positioning device in the computer being used (e.g., smart phone) can use the geographic coordinates to automatically determine the starting geographic location. In addition, at the time of authentication/identification, the patient's electronic medical records can be automatically retrieved by the program 110 and have a list of “pending” actions (including the order for liver enzyme blood test). By simply highlighting the pending liver enzyme test, and requesting “Schedule”, the program 110 automatically generates a query based upon the search variables of interest.

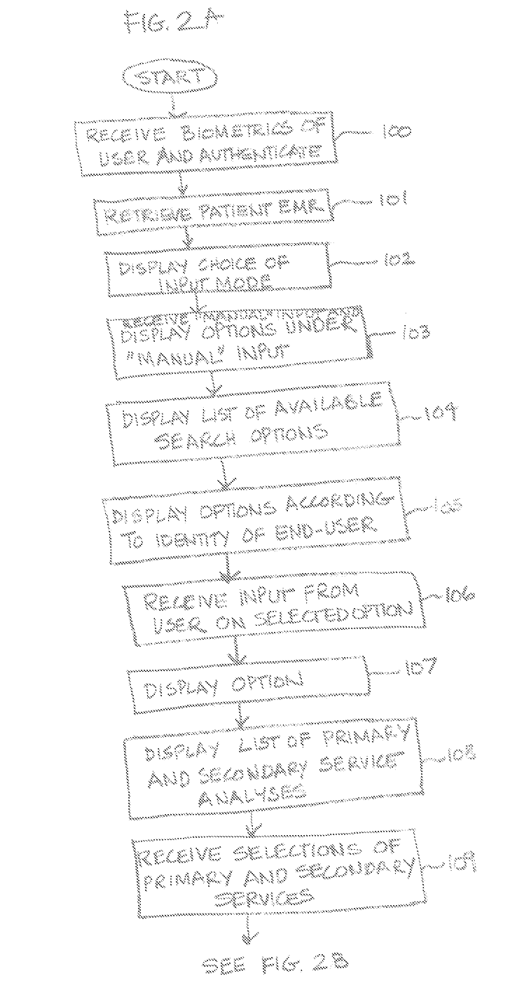

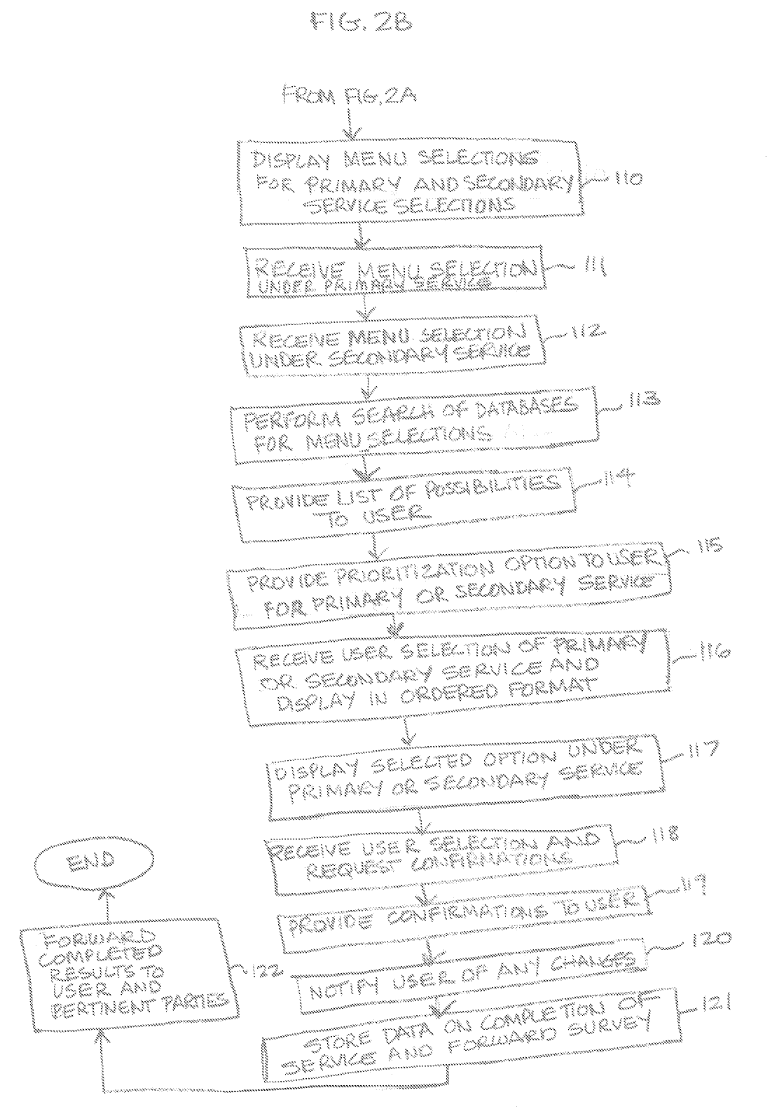

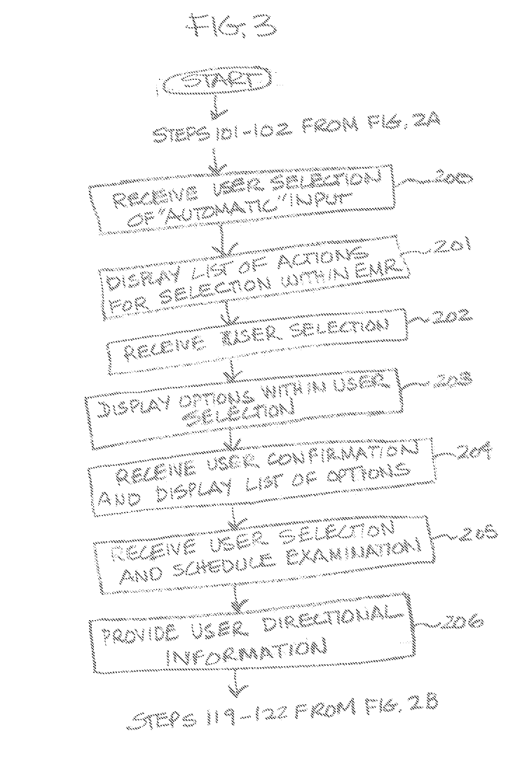

The present invention has two modes—and the steps and options available to the end-user in performing the search and examination scheduling are summarized below (see also, FIGS. 2A-2B):

A. First Mode

Step 100: The program 110 receives patient authentication/identification from the user/patient, using Biometrics (i.e., passwords, fingerprint, voiceprint, etc.), and checks it against the biometrics data for all patients in the database 113, 114. If the biometrics match, then the patient is given access to the program 110. If not, then the patient is not provided access to the program 110.

Step 101: Once authentication is completed, and the biometrics match the patient, and access is provided to the patient, the program 110 automatically retrieves the patient's electronic medical record folder.

Step 102: The program 110 then displays a choice of input mode—“Manual or Automatic”.

Step 103: The program 110 receives the patient's selection of “Manual Input” option, and then displays options, including “Search”, “Records” etc.

Step 104: The program 110 then receives the patient's input of the “Search” selection, and provides a list of available “Search” options.

Step 105: The program 110 then displays a list of options according to the identity of the individual end-user, so that, for example, patients are provided with scheduling options for examinations, appointments with clinicians, etc., and medical providers are provided with scheduling options for medical tests, training options, etc.

Step 106: The program 110 then receives the inputted selection of “Schedule Test” from the patient.

Step 107: The program 110 will then display the “Test” menu.

Step 108: The program 110 then receives the patient's input of the name of the test of interest (i.e., Laboratory: Liver Enzymes Profile) and displays a list of Primary and Secondary service analyses. As stated above, Primary Service Analyses include operational efficiency (e.g., timeliness), quality (e.g., clinical outcomes), cost-efficacy (e.g., comparative cost), customer service/satisfaction (e.g., subjectively perceived value of the specific product and/or service being utilized), and safety (e.g., iatrogenic complications). Secondary Service Analyses include geographic location, demographics, availability, pedigree (experience and training), technology, and economic profile.

Step 109: The program 110 then receives the patient's selections of two options—one under Primary service (i.e., Geographic Location), and the other under Secondary service (i.e., Availability).

Step 110: The program 110 then displays menu selections for Geographic Location, such as search radius or address, etc., and selections for Availability, such as a particular date/time, or “Next Available”.

Step 111: The program 110 then receives the patient's input for search radius under Geographic Location, which includes the starting geographic location and a 15 miles search radius.

Step 112: The program 110 also receives the patient's selection under Availability of “Next Available”.

Step 113: The program 110 then performs a search of the database 113, 114 of authorized providers within the defined geographic area of interest and cross-references the information with the first available appointment (i.e., for the test of record).

Step 114: The program 110 then displays a hierarchical list of possibilities to the user for review.

Step 115: The program 110 then presents the patient with an option to prioritize the list based upon either geographic Location or Availability.

Step 116: The program 110 then receives the patient's selection of Availability (Secondary Service—rather than Primary Service), and displays the list in chronological order, beginning with the service provider with the shortest waiting time for scheduling.

Step 117: The program 110 then receives the patient's selection of desired service provider and the program 110 displays a “Schedule” option.

Step 118: The program 110 receives the patient's selection of “Schedule” option, and then schedules the appointment, with a request for confirmation receipt and acknowledgments from both the patient and service provider.

Step 119: The program 110 will then automatically provide a confirmation receipt for the patient, along with computer generated directions to the service provider location (from the recorded starting location).

Step 120: The program 110 will automatically notify the patient by designated electronic means (i.e., email, fax, text, etc.), if any scheduling change was to occur before the scheduled time of exam, and the program 110 will present the patient with the option to reschedule or cancel.

Step 121: After the examination is performed, and the program 110 receives an update from the clinician and/or laboratory of same, with the results stored in the database 113, 114, the program 110 records the date/time of test completion for the purposes of tracking Operational Efficiency and the program 110 presents the patient with a standardized survey document to assess Customer Satisfaction.

Step 122: The program 110 then automatically forwards the completed test results to the patient and ordering physician.

B. Second (Automatic) Mode

Steps 100-102: These steps are the same as above.

Step 200: The program 110 receives the patient's selection of “Automatic” input (see FIG. 3).

Step 201: The program 110 then presents the patient with a list of all pending actions within his/her electronic medical record, such as “Laboratory”, “Reports” etc.

Step 202: The program 110 receives the patient's section of Laboratory: Liver Enzymes Profile.

Step 203: The program 110 displays an option for the patient to Schedule/First Available, which patient confirms.

Step 204: The program 110 receives the patient's confirmation of First Available, and then uses GPS to determine the patient's current location, and retrieves a list of authorized test providers in closest proximity to that location, and displays same with a chronologic list of first available appointment times.

Step 205: The program 110 then receives the patient's selection of location and time of choice, and schedules the examination.

Step 206: The program 110 then provides GPS directions to the service provider's location to the patient.

The remaining steps are the same as Steps 119-122.

For those services which are not typically provided on an appointment basis, the program 110 of the present invention can also be used to track Availability based upon existing workflow demands and backlogs. As an example, patients seeking to visit a hospital emergency room (ER) for a non-threatening but timely medical condition (e.g., dizziness), may wish to search local ER waiting times prior to initiating travel. Participating service providers would have the ability to report existing patient backlogs, waiting times, and physician availability.

In addition to this “real time” Availability data, the patient may also wish to use the program 110 to search the historical Availability data of the local ER service providers, along with Customer Satisfaction data to assist in the decision making process. Having this combined “real time” and “historical” data available, would provide an effective means with which an individual patient can make an educated and well informed decision as to which prospective service provider best fulfills their needs.

Note that the patient can go one step farther, and use the program 110 to search for data specific to their clinical condition (i.e., dizziness); and obtain records of ER waiting time and customer satisfaction for patients experiencing the same or similar medical conditions. In this exemplary scenario, the patient could be presented with comparative institutional waiting times (real time and historical) for three local ERs, along with the individual Quality ratings of each of the ER physicians currently on duty. This illustrates how the program 110 of the present invention can be used to obtain contemporaneous and historical data, on both individual and institutional levels to assist in data-driven service provider selection.

While not all service providers may elect to participate, another unique option for the present invention is to utilize the database 113, 114 and derived analytics for “preferential” scheduling and/or Availability. In this exemplary scenario of the patient experiencing dizziness, he/she may have identified the institution and individual service providers of choice and requested the specific availability and waiting time of a specific physician on duty. For example, there are three ER physicians currently on duty at the institutional provider of choice. The program 110 analyzes the individual ER physicians' data; for example, in this case the patient has indicated a strong preference for one of the three ER physicians (i.e., Dr. Smith). When requesting the availability status and anticipated waiting times for the physicians on duty, the program 110 informs the patient that the estimated waiting time for Dr. Smith is 50 minutes, while the respective estimated waiting times for his two colleagues (Drs. Jones and Dunston) are 20 and 30 minutes. The patient can elect to preferentially register on-line (as opposed to in-person), if the facility provides for on-line ER registration. In order to do so, however, the ER may request a payment guarantee using a credit card, which can also be accomplished using the program 110 of the present invention and Biometrics.

The advantages of this on-line registration using the program 110 of the present invention, include the following:

a) The program 110 expedites patient registration and immediately places the patient in the ER queue.

b) The program 110 provides for preferential service provider selection (i.e. Dr. Smith).

c) The program 110 provides the service provider with instantaneous patient-specific clinical data, in order to facilitate the triage process and fast-track additional exams and/or orders (e.g., schedule head CT for evaluation of dizziness).

d) The program 110 automatically retrieves all patient-specific clinical data from the electronic patient record (EPR), which includes data both in and outside of the institution of record. (In this particular example, the data retrieved from the database 113, 114 by the program 110, may contain images and report from a recently performed head CT at an outside institution, which may obviate the need for a repeat head CT at this time).

e) The program 110 provides an electronic mechanism for patient informed consent related to access of pertinent medical records and notification of patient-requested service providers (e.g., personal primary care physician).

f) The program 110 creates an electronic audit trail of all consumer-service provider communications, actions, and commerce.

g) The program 110 provides a consumer-specific profile for the ER service provider which contains a variety of patient specific data including (but not limited to) individual needs and preferences, demographics, education, compliance, etc.

The net result is that the program 110 of the present invention provides an objective method in which consumers can generate targeted searches and queries in accordance with their own needs and preferences (which can be recorded by the program 110 for future use in automated and recommended computer-generated searches), can initiate action to expedite workflow, and can provide a secure mechanism for automated data retrieval.

In order to expedite workflow (and reduce input errors), a number of customizable and automated search options can be initiated using the program 110. The first and most straightforward is a “fixed” search, which includes a pre-defined set of search criteria for a specific task. An example of a “fixed” search would be that of a cost comparison of service providers within a defined geographic radius for a pharmaceutical, medical service, or test. Once the specific search criteria are entered into the computer system by a specific end-user, the program 110 can automatically initiated the search and retrieve the information.

In one example, a patient John Davis is prescribed a new medication by his family physician. Since he is paying for this drug “out of pocket”, he is interested in locating the least expensive service provider (i.e., pharmacy) within a 15 mile radius of his home. In addition to Cost-Efficacy, Mr. Davis is concerned about Safety, since he has read about the myriad of dangerous complications relating to side effects, allergic reactions, and drug interactions. As a result, Mr. Davis accesses the program 110 and creates a “fixed” search (which he files under Cheap and Safe). Each time he enters this code, the clinical service of interest (e.g., drug prescription, medical procedure) will be subject to a search which ranks service providers in a 15-mile radius (from his home or other designated address) for comparative cost and safety measures.

In addition to the user entering the prompt (Cheap and Safe), an automated search can be generated by the program 110 based upon a pre-defined schema. In this exemplary scenario, Mr. Davis has requested that each time a new prescription order is recorded in his electronic patient record (EPR), an automated search query will be generated by the program 110 using the aforementioned search criteria. Once the data is reviewed by Mr. Davis, he can in turn generate an electronic order using the program 110 (e.g., Prescription fill) from the selected pharmacy. The pharmacist will receive the order electronically by the program 110 (i.e., email, fax, etc.), confirm receipt of same using similar means, and have all relevant medical records available for review at the time the prescription is filled.

In an alternative to the user-defined Search, the program 110 can initiate an Automated Search, which can be the result of an individual end-user's pre-defined criteria (such as the aforementioned Cheap and Safe search each time a new drug order is posted), or historical use. In the example of the prescription refill for Mr. Davis, the program 110 can track the date in which a previously issued pharmaceutical is due to be refilled, and automatically provide an electronic alert/prompt (i.e., email, text, fax, etc.) to the patient notifying them of both the need to refill the prescription, as well as of the automated search results the patient has used as a default. In this particular example, Mr. Davis' default search criteria (i.e., Cheap and Safe) is used, and the program 110 automatically generates and forwards, via electronic means (i.e., email, text, fax, etc.) a priority list for him to review. The new search may reveal a change in priority order from the prior search and the program 110 will provide the patient with the options of:

a) renewing at the old pharmacy of record;

b) ordering from the new pharmacy with the highest rated search results;

c) modifying the order using new search criteria;

d) placing an order at an alternative provider.

The same mechanism can be automatically applied by the program 110 for new or modified prescription orders, which have been generated by one of Mr. Davis' physicians. As an example, Mr. Davis' primary care physician (Dr. Levin) has elected to change his anti-hypertensive treatment based upon new quality and safety data published by medical journals and stored within the database 113, 114. This new data was received by Dr. Levin via the program 110 sending him an automated prompt (i.e., email, text, computer menu prompt, etc.) based upon the program's 110 meta-analysis of the database 113, 114, in which the program 110 performs a monthly review of “best clinical practice” guidelines.

When Dr. Levin placed the order on Mr. Davis' electronic patient record (EPR), a number of electronic notifications (i.e., texts, emails, etc.) were automatically sent by the program 110 to Mr. Davis, and to all of the appropriate clinical providers (e.g., pharmacist, insurance company, cardiologist). In the electronic notification by the program 110, the recommended modification in service (i.e., pharmaceutical change) was noted by the program 110 along with accompanying data to support the decision. In the event that Mr. Davis or any one of the clinical providers have questions or comments, these would be automatically recorded by the program 110 and electronically copied to all involved parties.

Upon receiving the recommendation from the program 110 along with an agreement from the cardiologist, Mr. Davis selects the option for the program 110 to search for a pharmacy provider based upon the default search criteria for the new drug. In addition, any changes in insurance company payments (e.g., co-pay) would be automatically provided by the program 110 to him, thereby providing a quick and easy cost comparison between the “new” and “old” drugs of record.

In the event, that the cost of the “new” drug is higher, Mr. Davis may elect to request his physician to confer with the insurance company or adjust the order in keeping with his economic restrictions. Since the comparative clinical data is readily available and searchable, this provides a clinically and economically effective means with which consumers, clinical service providers, and third party payers can how determine “best practice’ guidelines can be utilized in individual patient-decision making.

In the case of historical use, an automated search option by the program 110 could be initiated whenever a new clinical service request is posted by a user, which is comparable to a previous clinical service request for that same end-user. In this example, the consumer is a family practice physician (Dr. Sully); who is interested in referring one of his patients for cardiac bypass surgery. Before making a recommendation to the patient, Dr. Sully wants to search for cardiac surgeons in a 60-mile radius (Geographic Location), who can accept the patient's insurance plan (Economic Profile), have high clinical outcomes measures (Quality) and low complication rates (Safety). Thus, Dr. Sully would initiate the program 110 as described above, and implement a Search under these parameters. Once Dr. Sully has completed his search, he presents the patient with a limited number of service provider options which fulfill the search criteria—either in person, or electronically (i.e., email, text, fax, etc.).

A month later, Dr. Sully is consulting with another patient, who is diagnosed with severe coronary artery disease (based upon cardiac catheterization results). Upon entering the treatment recommendation of cardiac bypass surgery in the patient's EMR, the program 110 automatically prompts Dr. Sully as to whether he would like to generate a Search for cardiac bypass surgery providers using the criteria from his prior searches.

This illustrates an important feature of the invention; namely that automated prompts by the program 110 are tied to the historical search and workflow of each individual end-user, which can transcend individual patients. In this case, the end-user (i.e., consumer) is a physician; therefore, the artificial intelligence used in predicting future search requirements from past performance is tied to the physician's records and not solely that of the individual patient.

If Dr. Sully was to accept the automated search prompt from the program 110 for locating a cardiac bypass surgeon, the new search would be generated by the program 110 using the data from the new patient (and not the old). In this case, the new patient's insurance information (Economic Profile) and home address (Geographic Location) would be used by the program 110 to generate the search analysis. This illustrates the adaptive nature of the invention to utilize data intrinsic to each individual patient; and not to simply repeat the search using the data of a prior search recipient.

Another form of Automated Search takes the form of Predictive Analytics, which is based upon historical use of both the individual end-user, as well as that of comparable end-users. This type of automated search by the program 110 utilizes the information within the individual end-user profile stored in the database 113, 114 (see below), the medical service being analyzed, and the historical records to prior searches, to proactively predict what specific context and user-specific queries would be of potential relevance. The variables contained with the individual end-user profile include: Demographics, Socioeconomic status, Education, Geography, Risk factors, Genetics, Medical/Surgical History, Pharmacology, Personal Preferences, and Insurance.

An example of how predictive analytics can be used to automate medical service provider searches can be illustrated in the case of a patient (Mrs. Smith) who is told by her clinician that she has a mass on her mammogram, which is suspicious for cancer, and requires biopsy for definitive diagnosis. Her gynecologist refers her to a local general surgeon, who recommends to Mrs. Smith that she undergo a surgical biopsy, which can be performed in his outpatient surgical center. Having had no past significant medical or surgical experience, Mrs. Smith decides to take the advice of the consulting surgeon and undergo the biopsy. Before doing so, however, a family member suggests that she explore all options.

Using the proposed program 110, Mrs. Smith generates a query to compare local service providers. As different search options are presented to her by the program 110, Mrs. Smith generates a query to determine the comparative Quality measures of surgeons in her local geographic area for the diagnosis of breast cancer. In addition to displaying to Mrs. Smith this list of Quality ratings, the program 110 identifies several other search parameters which have been used in high frequency for end-users with similar individual profiles and clinical context. In the course of presenting this search data to Mrs. Smith, the program 110 also presents the historical frequency with which these search variables have been used. Exemplary statistics are:

Primary Service Analyses:

1. Quality (97%)

2. Safety (91%)

3. Customer Services (84%)

4. Cost-efficacy (41%)

5. Operational efficiency (26%)

Secondary Search Analyses:

1. Geographic Location (99%)

2. Pedigree (92%)

3. Economic Profile (74%)

4. Availability (40%)

5. Demographics (16%)

6. Technology (2%)

Based upon comparative search statistics of similar end-users for the same search context, that the program 110 can generate, the program 110 identifies those search variables of highest frequency (i.e., over 80%), and offers to incorporate these into the current search, if desired by the user. By the user simply clicking on the option for “Extend Search”, the search is now modified by the program 110 in keeping with the search characteristics of comparable end-users. The resulting search output is far different than would have been generated by the program 110 using Quality alone. Of the top 10 surgeons presented (based on composite scores for the six search categories), none provide service at the local hospital. Based upon this information, Mrs. Smith selects a surgeon in a nearby town (15 miles away).

An additional automated search option provided by the program 110 includes “Cut and Paste”, where an end-user can import the search protocols of another colleague. In doing so, the program 110 will automatically generate searches using the defined search variables of other user(s), whenever a pre-defined clinical service task is entered into the computer system. This is particularly useful when individual consumers have identified themselves to be part of a similar group of end-users (i.e., peer reference group). Examples may include patients with similar diseases, physicians with similar practice types and patient demographics, researchers with similar scientific areas of interest, or hospital administrators with similar institutional demographics.

These peer reference groups can be created manually (by individual end-users identifying themselves as being part of a specific group and storing same in the database 113, 114), through end-user surveys (where end-users would provide individual characteristics, preferences, and needs and the program 110 would match them with other end-users of similar characteristics) or using the program's 110 artificial intelligence to identify end-users with similar search and analytics.

In the event that an end-user elects to participate in a peer reference group, the user would be provided by the program 110 with the option to communicate with other group members. Subsequent analytics run by the program 110 can be extended beyond the individual end-user to also include peer reference group members; thereby providing a method for comparative clinical outcomes analysis within peer reference groups.

In an example, a member of a peer reference group (e.g., community hospital cardiologists) may have significantly higher performance analytics (e.g., Safety) then other members of their respective group. Data analysis by the program 110 may reveal that one of the variables with high statistical significance is that one particular group member uses a different type of catheter in performing cardiac catheterizations than the majority of his peers. The derived data by the program 110 can be confidentially shared with participating group members using the program 110, providing individual group members with the ability to make data-driven decisions as to product/service selection with the hopes of improving their own performance/outcomes data.

The program 110 also provides an effective tool for delivering customizable education and training to end-users. This could be based upon the analyses by the program 110 of an individual end-user's historical search and queries, use patterns by the peer reference group members, prospective analysis of performance metrics within the database 113, 114, or new/modified topics of interest.

In addition to the various data analytics derived by the program 110 from searches and queries, educational content links can be created by the program 110, to the various products and services being analyzed. This educational content can come from a variety of sources including but not limited to: scientific journals, societal publications, governmental policies and recommendations, lay publications, Internet portals and websites, newsletters, and marketing brochures. Due to the fact that there can be no objective means in which to analyze the intrinsic value of this content, end-users will be provided by the program 110 with the ability to subjectively rate these various forms of educational content based upon a number of criteria (e.g., relevance, timeliness, objectivity, reliability). These ratings can in turn be used by individual end-users to direct the program 110 in automated content searches and deliveries, in keeping with each individual end-users' profiles, preferences, and needs. End-users can also utilize the program 110 to create hierarchical rankings of education content and providers to direct how future educational content is processed and delivered by the program 110.

As an example, a patient may place a high education rating on content derived from a specific internet website (e.g., medical website) relating to a specific medical diagnosis (e.g., breast cancer), and can instruct the program 110 to automatically retrieve and store in the database 113, 114, all new educational content pertaining to that specific diagnosis on that particular website, to their individual “education” electronic folder. The content, presentation, notification and purging within these educational folders can be customized using the program 110, based upon individual end-user's preferences. At the conclusion of content review by the end-user, the end-user is provided by the program 110 with an option to rate the perceived value of the content, which can in turn be used to improve future content selection of that individual end-user.

In addition to unsolicited education content delivery by the program 110, solicited educational delivery can be performed by the program 110, in keeping with database 113, 114 analytics and professional guidelines. As an example, if a specific service provider's performance analytics are determined by the program 110 to be significantly below that of his/her peer group, or do not meet criteria of the organization in which they are employed, or demonstrate downward trending, an automated (or solicited) educational program 110 may be generated, which is specifically tied to the area of concern.

In this particular example, performance analysis of a primary care physician by the program 110 demonstrates that he/she has particularly low Safety performance metrics in their ordering of anticoagulation therapy. As a result, the hospital in which he/she practices has requested that the physician undergo remedial education in order to maintain active privileges. Based upon the specific data of interest, a number of educational content has been presented by the program 110 to the user for review. The specific content accessed, date/time, and relevance to the educational exercise are recorded by the program 110 in the database 113, 114 for external review by the user. In the event that the content is part of a continuing medical education (CME) program, the scoring of post-test questions by the user are also recorded by the program 110. Subsequent performance analysis by the program 110 of the physicians' database 113, 114 is later reviewed by the user, and can be analyzed by the program 110, to determine whether the solicited educational endeavor has positively impacted performance. If not, additional action may be required, which can take the form of additional education for the user, targeted peer review/oversight, and/or reduction of user privileges. This post-education analysis and follow-up, is also recorded by the program 110 in the database 113, 114 to assist in future educational content analysis and selection by other end-users.

Another important education/training feature of the program 110 is the ability to deliver combined educational content and data as it relates to specific services or products. As an example, if a new pharmaceutical has just received Food and Drug Administration (FDA) approval for a specific clinical application (e.g., refractory seizures), the educational content and supporting clinical data may be automatically sent by the program 110 to specific physicians of interest (e.g., neurologists specializing in the treatment of seizure disorders). Alternatively, if a medical practice or institution is providing a new service (e.g., aortic aneurysm percutaneous stent graft placement), the provider may wish to market this new service by having the program 110 send the educational content and clinical data to prospective consumers (e.g., patients with known aortic aneurysms, local vascular surgeons). The data provided to the consumers by the program 110 would include national, regional, and local performance metrics for the specific procedure, along with specific performance data of the clinicians marketing the service. In this manner, consumers would have the opportunity to select service providers based upon objective performance data, along with educational content of direct relevance.

To illustrate the functionality of the invention and how it works, a four representative examples are presented below.

In a first example, a patient elects to schedule a screening mammogram for breast cancer detection. In a second example, a patient needs to schedule semi-emergent cholecystectomy for acute cholecystitis. In a third example, a patient moves to new area (out of state) and needs to find primary care physician. Finally, in a fourth example, a physician wants to initiate anti-hypertensive therapy on a new patient to her practice.

In the first example (screening mammogram scheduling), a 35 year old female patient (Ms. Jones) is told by her primary care physician (Dr. Smith) that annual screening mammograms need to be instituted. While the patient is asymptomatic and in good health, she is somewhat anxious due to the fact that her mother was recently diagnosed with breast cancer, placing her at increased risk. Her primary care physician offers to have her scheduled in the medical imaging office located in the same medical professional building. When she questions the primary care physician as to the medical imaging office's technology, staff experience, and diagnostic expertise she is told by Dr. Smith that their performance has been “more than adequate”.

The patient declines the offer by the primary physician's staff to schedule the mammogram while in the office, and elects to do a little background research to explore her opportunities. Using the Internet, Ms. Jones learns that a number of differences exist in the imaging technology used for breast cancer detection. The most sophisticated technologies employ a form of digital mammography, which has been shown in scientific studies to improve breast cancer detection and potentially use less ionizing radiation than alternative options. Ms. Jones also learns that diagnostic accuracy (as measured by sensitivity and specificity) varies between imaging providers and each individual radiologist's performance is recorded and analyzed, in accordance with the Mammography Quality and Standards Act (MQSA).

After learning this information, Ms. Jones elects to select an imaging provider based upon available technology, quality, and safety. Unfortunately, in the current practice environment, this information is not readily available, but the present invention would provide this information in a novel way to the consumer. In the present invention, the program 110 would provide the patient the option to list (in rank order) the specific analyses of highest priority, to guide provider selection. From the list of primary and secondary analyses, Ms. Jones selects the following:

Primary Analyses:

1. Quality

2. Safety

Secondary Analyses:

1. Geographic Location

2. Economic Profile

3. Technology

Using the input search variables entered by Ms. Jones, the program 110 queries the database 113, 114, and a hierarchical list of service providers is generated and presented by the program 110 which fulfills the search criteria. In order to accomplish this task, the program 110 must take into account in its analysis, both the individual profile of Ms. Jones, along with the specific context in which the search is undertaken. The profile on Ms. Jones takes into account a number of individual-specific variables (stated above), while the search context refers to the service requested (screening mammogram) and clinical indication (breast cancer screening).

In the process of the search, the program 110 has identified those providers with the highest quality and safety scores, taking into account MQSA data for diagnostic accuracy along with safety, which in this context is primarily determined by radiation dose (relative to industry standards). Those high ranking service providers are in turn cross-referenced by the program 110 with those providers fulfilling the secondary criteria. In order to accomplish this secondary analysis, the program 110 must correlate the patient-specific geographic and economic data.

For geography, Ms. Jones has listed two location options: home and work (which are separated by 20 miles). For economics, the program 110 correlates Ms. Jones' insurance provider information (specifically related to screening mammography), with the list of potential providers. In doing so, the program 110 narrows the list to those providers who participate in Ms. Jones' health insurance network. For the third (and lowest priority) variable in the secondary analysis, the program 110 factors in the type of imaging technology (specifically for mammography) available among higher ranking service providers.

The output list/data is displayed for Ms. Jones. Note that Ms. Jones has the option to highlight on the display, using a navigation device, any individual variable in the data presented, which in turn provides more detailed information and search options. During the course of continued operation, the program 110 tracks Ms. Jones's input commands and activity (using automated tracking software) to identify Ms. Jones' tendencies and automatically display those to her through predictive analytics. If, for example, Ms. Jones frequently requests a numerical score for each of the search categories, the program 110 will automatically present this data as a default, and incorporate this data into her individual data presentation profile.

The data displayed for Ms. Jones is shown in Table 1.

TABLE 1

| | | | | Eco- | Tech- | Com- |
|---|---|---|---|---|---|---|
| | Quality | Safety | Geography | nomics | nology | posite |
| Facility | 60% | 40% | 50% | 40% | 10% | Score |
| Acme | 92 | 90 | 96 (home) | 76 | 100/75 | 91 |
| Imaging | | | | | | |
| Suburban | 84 | 88 | 90 (work) | 85 | 80 | 88 |
| Hospital | | | | | | |
| Imaging | 91 | 72 | 94 (work) | 90 | 95 | 84 |
| Associates | | | | | | |
| Priority | 90 | 75 | 88 (work) | 80 | 100/90/65 | 83 |
| Womens | | | | | | |
| Imaging | | | | | | |

In the course of the reviewing the search results of Table 1, several items of interest are noted by Ms. Jones. For the highest ranked service provider, there are two different technology scores, indicating that different mammography options are used by that provider. If Ms. Jones opts to select this service, she needs to ensure that the highest rank technology option is scheduled for her exam. In addition, Ms. Jones notes that the location for Acme Imaging is in close proximity to her home address (unlike the other options), which will affect the time scheduling options for her. For economics, Ms. Jones wants to evaluate the lower score attributed to Acme Imaging before selection. By highlighting on the display, the economic score for Acme Imaging, additional data is presented to her by the program 110, notifying her that the calculated “out of pocket” expense at this facility will be estimated at $40 (as opposed to $15 at Imaging Associates).

After considering the various options, Ms. Jones decides to initiate a scheduling search using the program 110 for three of the four options (eliminating Suburban Hospital due to the fact that she prefers avoiding a hospital provider). When selecting the scheduling option (and highlighting on the display, the highest technology scores for those facilities with multiple technologies in use), the following options are presented to her by the program 110:

1. Acme Imaging: 06/04/11 11:30 am, 06/07 4:00 pm, 06/08 1:30 pm

2. Imaging Associates: 06/03/10 8:30 am, 06/03/10 1:00 pm, 06/03/10 3:30 pm

3. Priority Womens Imaging: 06/04/10 at 12:30 pm, 06/05/10 at 10:00 am, 06/07/10 at 3:00 pm

If Ms. Jones selects Acme Imaging (which is near her home address), she must either take off of work on 6/4/11 or leave work an hour early on 6/07/11. Alternatively, she can take the earlier appointment at Imaging Associates on 6/03/10 and arrive an hour later for work on that day. She decides to choose Acme Imaging based upon its higher composite score and selects the scheduling option of 06/07/11 at 4:00 pm on the display.

Upon doing so, the centralized scheduling option of the program 110 is employed; the exam is scheduled by the program 110 (to use the digital mammography device with the 100 Technology Score), and receipt verification is automatically sent by the program 110 to Ms. Jones during the program 110 or via other electronic means (i.e., email, text, etc.). Since only one radiologist is interpreting screening mammograms at Acme Imaging on the day of her scheduled exam, no additional options are presented by the program, 110 for “radiologist selection”. If, on the other hand, multiple radiologists were available at the time of the scheduled exam, an additional option may be made available by the program 110 for provider selection (which could be done in conjunction with comparative Quality score data).

Note that the relative weighting of each variable in the primary and secondary analyses can be adjusted by the program 110 in accordance with individual end-user preference. If specific weighting preferences are not inputted, default weighting measures will be employed by the program 110 based upon historical use (of the individual user and context) and community standards.

In the second example, a semi-emergent cholecystectomy is required for Mr. James, who has been diagnosed with acute cholecystitis by his family practice physician. The physician recommends that Mr. James go to the local hospital emergency room, but Mr. James elects not to, based upon a prior bad experience. Since time is somewhat urgent, Mr. James decides to query institutional provider options based upon the following search criteria:

Primary Analyses:

1. Quality

2. Operational Efficiency

Secondary Analyses:

1. Availability

2. Geographic Location

Note that in this case, the provider search by the program 110 was directed towards institutional, and not individual, service providers. As a result, the derived analyses by the program 110 will result in a display of institutional data, independent of individual service providers (e.g., surgeons). Since time is of the essence, Mr. James has entered an extremely high weighting factor (90%) for Availability. The results of the search are shown in Table 2.

TABLE 2

| | | Operational | Avail- | Geographic | |
|---|---|---|---|---|---|
| | Quality | Efficiency | ability | Location | Composite |
| Institution | (60%) | (40%) | (90%) | (10%) | Score |
| Mt Sinai | 54 | 86 | 97 | 75 | 80 |
| Hospital | | | | | |
| St Agnes | 80 | 74 | 82 | 68 | 78 |
| Hospital | | | | | |
| University | 92 | 45 | 95 | 20 | 76 |
| Medical | | | | | |
| Center | | | | | |
| Atlantic | 81 | 78 | 68 | 99 | 76 |
| Hospital | | | | | |

After reviewing the options displayed in Table 2, Mr. James decides to eliminate University Medical Center as an option, due to the fact that it is far away and a teaching hospital. While Atlantic General is by far the closest option, it's relatively low Availability score is of concern.

In order to gain more insight as to timing for the requisite surgery, Mr. James highlights on the display, the Availability category, and requests an estimated response time (in hours) for cholecystectomy. Due to the fact that this data is dependent upon up to the data conditions in each surgical suite, a high priority alert is transmitted by the program 110 to the surgical suites of each of the three institutional options. The administrators in turn input time estimates for the requested procedure, based upon the current operating room schedules, availability of the on-call surgeon, and patient's medical records:

Mt Sinai Hospital: 8 hours

St Agnes Hospital: TBD

Atlantic General Hospital: 24 hours

Due to the fact that the surgeon on call is not responding to communication, St Agnes Hospital was unable to provide a time estimate. Before committing to Mt. Sinai Hospital, Mr. James elects to run the following query on quality, safety, pedigree, and composite score, on the on-call surgeons (i.e., individual profile analysis) for the three institutions being considered. The results are shown in Table 3.

TABLE 3

| | | | Pedigree | |
|---|---|---|---|---|
| | Quality | Safety | (Experience) | Composite |
| Provider | (50%) | (50%) | (100%) | Score |
| Dr. A Jones | 72 | 74 | 45 | 68 |
| (MS) | | | | |
| Dr. P Buchanon | 80 | 56 | 72 | 74 |
| (SA) | | | | |
| Dr. N Knight | 94 | 90 | 85 | 91 |
| (AG) | | | | |

In reviewing the combined institutional and individual provider scores provided by the program 110, Mr. James is faced with selecting the most time efficient option versus the higher quality option. His primary concern is the relatively low experience score of Dr. A Jones at Mt Sinai. After highlighting the Pedigree category on the display, and being provided by the program 110 with more detailed data, Mr. James learns the relatively low score of Dr. Jones is largely due to the fact that he is a recent graduate with far less experience than the older and more experienced Dr. Knight. When performing a temporal analysis over the past two years, Mr. James learns that Dr. Jones has performed the specific surgery in question (i.e., cholecystectomy) 18 times, as opposed to Dr. Knight who has performed the same surgery 46 times over the past 2 years.

After considering his options and discussing the time estimates with his primary care physician, Mr. James selects Dr. Knight at Atlantic General. After electronically selecting Dr. Knight for the requested semi-urgent cholecystectomy, both the operating room at Atlantic General Hospital and Dr. Knight are contacted by the program 110 as a priority status, and pre-operative preparations are begun. Mr. James is contacted by Dr. Knight's staff by electronic means (i.e., telephone, text, email etc.) and given instructions to proceed to the surgical department at Atlantic General, where pre-operative orders are waiting. In the meantime, Mr. James' electronic medical records are automatically transferred by the program 110 to Dr. Knight, the surgical department coordinator at Atlantic General, and his insurance provider for review and authorization.

The third example is fairly straightforward and commonplace. A 67 year old female retiree (Mrs. Angle), and widow, is moving to another state to be closer to her daughter and grandchildren. As in any long distance move, Mrs. Angle will be faced with developing a new healthcare provider network—most important of which is a primary care physician. Because she has a number of ongoing medical problems related to chronic diabetes, it is important that see identify someone who is adept at both primary care medicine and has experience and expertise in diabetes treatment.

The traditional method of finding a new healthcare provider by going through a local hospital or insurance provider is problematic, largely because it leaves so much to chance. At the same time, most of the elderly neighbors she has spoken to use physicians who are no longer taking new patients. As a result, Mrs. Angle can utilize the program 110 of the present invention to identify prospective physician providers, in keeping with her requirements for clinical expertise, availability, geographic proximity, acceptance of Medicare, and bedside manner.

Due to the fact that Mrs. Angle is not computer literate, she would have a difficult time utilizing the program 110 data search and query. For those individuals who have a difficult time with computers, educational and assistance programs are made available online, or at medical providers, to assist in the provider selection process. The online program 110 offers a series of electronic tutorials which walk through end-users on a step-by-step basis, after first establishing their personal profile based upon education, computer proclivity and personality. The alternative mode of operation consists of speech input to a series of program-generated questions, which simulate the electronic search and query process.

If Mrs. Angle has already been entered into the comprehensive electronic medical record database 113, 114 by the program 110, her medical records and previous search history has already been established. If this is not the case, then it must be initiated for the first time by the program 110; which begins with the creation of a user-specific profile as noted above. If Mrs. Angle has had her medical records previously recorded into an electronic database 113, 114, this can be automatically transported by the program 110 to the universal medical database 113, 114 upon authorization by the user and/or institutions etc.

After the user-specific profile has been completed and entered into the database 113, 114 using the program 110, Mrs. Angle is then requested by the program 110 to provide her individual preferences relating to healthcare delivery. This would include rating the different categories of primary and secondary provider analysis (as noted above) in order of priority. This provides a default mechanism for future search and query functions for the program 110 to automatically prioritize those variables which have been reported to be of greatest priority. During the course of entering these priorities, Mrs. Angle provides the following rank order as defaults for future analyses:

Primary Analyses:

1. Customer service

2. Cost-efficacy

3. Safety

4. Quality

5. Operational efficiency

Secondary Analyses:

1. Geographic location

2. Pedigree (experience and training)

3. Availability

4. Demographics

5. Technology

When asked by the program 110 to list any specific circumstances or requirements which play a major role in determining provider selection (both individual and institutional), Mrs. Angle enters into the computer system that bedside manner (i.e., customer service) is of extreme importance, along with cost-efficacy. With regards to Pedigree, she selects that she is looking for a primary care physician who has extensive experience in gerontology and treating diabetic patients.

After initiating a search for a primary care physician, the program 110 prompts Mrs. Angle with a series of questions, which include the following:

1. What geographic radius do you want to limit the search to?

2. Are you interested in searching for providers under the categories of “Endocrinologist” and “Primary Care Physician” or just one?

3. What economic restrictions exist regarding healthcare expenses (including medications)?

4. Do you have any personal preferences regarding physician demographics (e.g., age, gender, race, and ethnicity)?

Based upon answers to these questions, the program 110 generates a query profile for Mrs. Angle. In the search for selection of a primary care provider the following data is generated, as shown in Table 4.

TABLE 4

| | Customer | Cost- | | | | | |
|---|---|---|---|---|---|---|---|
| | Service | efficacy | Safety | Geography | Pedigree | Availability | Composite |
| Provider | (50%) | (35%) | (15%) | (40%) | (40%) | (20%) | Score |
| Dr. A. Suh | 94 | 82 | 80 | 72 | 96 | 35 | 82 |
| Dr. F. Charles | 90 | 74 | 78 | 74 | 76 | 45 | 76 |
| Dr. S. Tunney | 99 | 42 | 99 | 82 | 84 | 5 | 74 |
| Dr. C. Smith | 92 | 66 | 84 | 90 | 28 | 96 | 67 |

In order to assist Mrs. Angle in the selection process, the program 110 has highlighted certain data which are outliers (defined as markedly reduced relative to comparison statistics). By the program 110 activating these highlighted data (i.e., Availability for Drs. Suh and Tunney, Pedigree for Dr. Smith), an explanation is presented by the program 110 explaining how the data was derived and what the data means in practical terms. (This is one of the many educational components of the present invention—which is aimed at facilitating data analysis and understanding).

Once the program 110 activates this highlighted data, Mrs. Angle learns that the cause for Dr. C Smith's low Pedigree score is the result of three factors:

1. Recent graduation from residency resulting in limited post-graduate experience.

2. Medical school education in another country (Granada).

3. Low standardized test scores on during medical school testing.

The Availability scores for Drs. A. Suh and S. Tunney are the result of long patient waiting lists, which would translate into estimates of 65 and 120 days before appointments can be scheduled.

Realizing that these waiting times are unacceptable, Mrs. Angle restricts her search to the two remaining providers Drs. F. Charles and C. Smith. Upon further investigation of their individual pedigrees using the program 110, Mrs. Angle learns that Dr. F. Charles completed her residency in family practice, and has extensive experience with pediatrics and adolescent medicine. Dr. C. Smith also completed a family practice residency (in the United States) and has a special interest in gerontology. Due to the fact that Mrs. Angle has had a great deal of problems related to her chronic diabetes, she elects to perform a secondary search using the program 110 related to Diabetes. In this search, the listed providers are analyzed based upon performance scores related to diagnosis and treatment of diabetes. The results are shown in Table 5.

TABLE 5

| | | | Education/ | Cost- | | | Composite |
|---|---|---|---|---|---|---|---|
| Provider | Diagnosis | Treatment | training | efficacy | Complications | Surveillance | Score |
| Dr. F Charles | 68 | 66 | 58 | 80 | 45 | 60 | 66 |
| Dr. C Smith | 74 | 80 | 84 | 62 | 81 | 90 | 80 |

Before making a final decision, Mrs. Angle seeks to gain further insight into each of the providers' bedside manner, since this is of extreme importance to her. By selecting the Customer Service category of analysis of the program 110, a number of additional search options are displayed, all of which contribute to the comprehensive Customer Service analytics:

1. Patient education and training

2. Billing and insurance inquiries

3. Laboratory services

4. Medications

5. Nursing

6. Physician

7. Clerical staff

8. Communication

9. Scheduling

10. Subspecialty consultations

In a targeted search under Physician using the program 110, Mrs. Angle learns that Dr. Smith has received an individual customer service score of 94 and has a patient retention rate of 95% in the past two years. Dr. Charles has received a comparable individual customer service score of 80 with a two-year patient retention rate of 84%. As a result, of the combined general and disease-specific analyses, Mrs. Angle elects to schedule an appointment with Dr. C Smith, with the hopes of making him her primary care physician. The appointment can be automatically generated by the program 110 by selecting the “Schedule Appointment” option. Mrs. Angle subsequently receives confirmation receipt of the scheduled appointment by the program 110, along with directions to the office and authorization of medical records transfer to Dr. C Smith for her to complete and return.

In the last example, a primary care physician (Dr. Nettles) has just finished evaluating a new patient to her practice (Ms. Culver) who was found to have hypertension on physical exam. Ms. Culver denies pre-existing hypertension and states she has been in excellent health, is taking no current medications, and is new to the area. When asked about insurance, Ms. Culver states she is uninsured and unemployed. In order to select the most appropriate medication, Dr. Nettles enters the following search criteria in the program 110:

1. Cost

2. Safety

3. Quality

Under patient medical history, Dr. Nettles enters no current medications, no pre-existing medical conditions, no known allergies or adverse drug interactions, into the program 110. The program 110 then presents a list of potential pharmaceuticals which fulfill the search criteria, with preferential weighting given to cost.

When the patient, Ms. Culver arrives at the local pharmacy, she is asked to be identified through Biometrics. The program 110 Biometrics identifies Ms. Culver, with a long medical history and pharmaceutical history. The pharmacist notifies Dr. Nettles about this new information via electronic means (i.e., telephone, email, fax etc.) and inquires as to whether the order should be modified in accordance with this new found information.

Using this new data, Dr. Nettles re-enters the search criteria into the program 110, using the additional patient-specific data available. Based upon this new data (but same search criteria), the program 110 presents a different rank order list of recommended pharmaceuticals. Based upon this new data, Dr. Nettles changes the prescription order and updates her files on Ms. Culver. This exemplary scenario presented illustrates how the program 110 can utilize patient identification/authentication information to enhance data retrieval and accuracy of the derived data.

In addition to the more obvious applications relating to quantitative analysis of service performance, a number of other applications can be derived from the present invention, for the combined benefits of both healthcare consumers and providers. The applications include: Education and Training, Credentialing and Licensing, Hiring and Recruitment, Comparative Technology Assessment, Feedback to Providers on Search Queries, Trending Analysis, Automated Feedback and Prompts, Research, Creation of Consumer Networks, and Creation of Best Practice Guidelines.

The ultimate goal of the preset invention is to provide knowledge (through standardized and objective data), to be used for consumer empowerment and enhanced clinical outcomes.

Education and training is an integral component of the invention; with a variety of applications, depending upon the individual end-user. From a consumer perspective, the performance analytics of the program 110 can be used to quantify the comparative level of performance of their existing service providers (both individual and institutional), as well as automatically providing a list of “high achievers” within their frame of interest. This frame of interest can be defined by the program 110 by a number of different variables including geography (e.g., close proximity), economic profile (e.g., within a given insurance provider's network), availability (e.g., accepting new patients), technology (e.g., 64 detector CT scanner) and personal preferences (e.g., female provider with >15 years of clinical experience).

In addition to providing education and training opportunities for consumers, the present invention can also provide education and training for healthcare providers. An institutional provider could use the performance analytics of the program 110 to identify individual and departmental performance outliers (i.e., poor performers); in order to facilitate remedial education and additional staff training. As an example, if the medical imaging department within a given hospital is receiving poor performance scores (relative to peer providers), the data can be used for the program 110 to help identify the source(s) of the problems and offer opportunities for improvement. The data could show that the specific performance metrics (e.g., CT image quality) is caused by a specific technology (e.g., antiquated CT scanner), individual technologist, or specific exam type. By using the data to have the program 110 identify the potential sources of performance deficiency, the administrator can intervene by upgrading technology, offering the technologist additional training, or providing staff with clinical in-services targeting the specific exam type of concern.

Another application for the invention is credentialing and licensing of medical service providers, which can be individual or institutional. Due to the fact that the data contained within the database 113, 114 is standardized, meta-analysis can be performed by the program 110 which provides for a mechanism of comparative analysis over large sample sizes. The resulting analytics can take into account the unique attributes of institutional and individual healthcare service providers and provide comparative performance analytics in keeping with different profile groups. As an example, in the program 110 analyzing the Quality metrics or a group of physicians, the analysis can be stratified in accordance with the physician profiles. This allows for differences in physician education/training, practice type, geographic location to be factored into the analysis by the program 110. A family practice physician practicing in a small rural community hospital would not be compared with a pulmonologist practicing inn urban tertiary-care university hospital. The Quality metrics for each physician would be done by the program 110 so that each physician was being analyzed in keeping with his/her profile and compared with physicians of a similar profile.

Once these provider profiles are taken into account by the program, the resulting performance measures can be used to assist in provider (both institutional and individual) credentialing and licensing. The current model which is highly subjective in nature, time consuming, and resource intensive could in part be enhanced (or even replaced) by a standardized data-driven objective system, utilizing the performance metrics of the present invention. As an example, a provider (e.g., surgeon) requesting privileges to perform a new procedure could have his/her performance metrics compared by the program 110 to peers with a similar profile and have privileges granted or denied based upon objective performance. In the event that the privileges were denied, the provider would be given specific data by the program 110 as to the deficiency and have ample opportunity for targeted improvement; part of which could be based upon trending analysis and part on continuing education. This same approach could arguably be a significant improvement to the existing procedure for institutional credentialing, such as the Joint Commission on Accreditation of Healthcare Organizations (JCAHO).

The current model of individual physician state licensing could be replaced by a national model utilizing the performance metrics for standardized analysis. In the same manner that objective performance metrics can be used by the program 110 for analyzing provider applications for credentialing and licensing, they can also be used to assist in hiring and recruitment of healthcare providers. The current hiring model is dependent upon subjective (and biased) letters of recommendation, which do not provide an objective or reproducible mechanism for assessing historical performance relating to service delivery. An employer who is considering the application of an individual who has worked outside of the immediate area is at a distinct disadvantage in being able to objectively analyze the applicant's skills

Using the standardized data analytics of the program 110, the employer can reliably compare and contrast all applicants for the job; while taking into account profile differences of each individual and the institutions in which they practiced. In addition, the employer can apply differential weighting to the categories of analysis by the program 110, in keeping with the specific job requirements.

As an example, a hospital administrator would like to hire a new administrative director of laboratory services. The previous director has been dismissed due to problems with low employee morale and multiple complaints from patients and physicians. In the course of seeking a new director, the hospital administrator wants to find a qualified “outside” candidate, who is particularly strong in their interpersonal skills and consumer advocacy. As a result, the administrator places a high weighting to the Customer Service category of analysis in the program 110. When deciding between three viable candidates for the position, the administrator can objectively compare the inherent strengths and weaknesses of each candidate, relative to their historic performance metrics.

The next application of the present invention is technology assessment, which is an important factor affecting healthcare service performance. If one was to compare three different CT scanners in a hospital imaging department, they would find that technology differences may impact a number of performance deliverables including Operational Efficiency (e.g., time required to complete a given CT scan), Safety (e.g., radiation dose associated with different scanning technologies), and Quality (e.g., differences in image quality resulting from motion, with faster CT scanners experiencing less motion and higher image quality).

The program 110 provides the opportunity to perform a comparative performance analysis relating to decisions, staffing, scheduling, and quality assurance. In addition, a provider with a certain type of technology can utilize the performance data from providers with a similar profile to identify “best practice” guidelines.

As an example, a hospital has an older CT scanner which cannot be replaced due to financial constraints. A number of poor performance measures have resulted including poor image quality, high radiation dose, and problems with patient throughput. By utilizing the program 110 to identify institutional providers with similar technology and profiles, high performance providers can be identified. These higher performance providers (using the same technology) can in turn provide insights as to how service can be modified to improve performance.

Technology vendors can also use the performance data generated by the program 110 to identify the relative strengths and deficiencies of their own technology relative to that of their competitors. This provides an opportunity for future technology refinement and innovation. If, for example, a CT vendor learns that its technology is consistently providing lower Safety scores (due to higher radiation dose), it can use this data to assist in the development of low dose scanning technology, filters, and image processing. The incremental success of these technology refinements can in turn be directly measured through “before and after” data analysis.

While direct and instantaneous feedback of data searches by the program 110 is provided to the healthcare consumer, this search data can also be made available to the service providers. When competing providers are provided this data by the program 110, they are given the opportunity to investigate and better understand how they measure up against the competition and how these analytics are being used by consumers for provider selection.

As an example, a cardiologist (Dr. Willey) receives a monthly report of all consumer searches by the program 110, which identified him as a prospective service provider. In the search analysis using the program 110, he learns that he was selected by the consumer only 16% of the time; whereas a cardiologist in a nearby office (1 mile away) was selected 42% of the time. Further; Dr. Willey learns that the specific performance metric of greatest disparity between himself and the competing cardiologist was Availability. The reported time for an appointment was three weeks for himself and only five days for his competitor. Realizing that this performance category was weighted heavily for those consumers who selected his competitor, Dr. Willey decided to explore why is waiting times were so high. In doing so, he learned that the office manager was not utilizing electronic scheduling effectively, which ultimately led to a reduction in scheduling time from three weeks to seven days. Thus, the ability for providers to have access to the program 110 and utilize the search data can be empowering and educational and ultimately can lead to improved performance, when the provider is highly motivated to improve existing deficiencies.

While trending analysis was previously discussed, it is an important application of the invention, due to the dynamic nature of the data being analyzed. While individual metrics will be used by the program 110 to calculate “current” performance measures, they will likely have little overall effect, due to the cumulative nature of data over the lifetime of analysis. As a result, incremental changes in performance will not be easily observed by the consumer and may mask significant performance trends. The program 110 of the present invention provides a tool for consumers and providers to review performance analysis over defined time periods; thereby providing keen insight as to recent changes (and the various factors that contribute to these temporal changes).

In the previous example, it was noted how Dr. Willey used the historical search data to uncover a performance deficiency in his practice which was adversely affecting selection. As a result of this knowledge, Dr. Willey instituted changes in electronic scheduling, which resulted in a significant reduction in appointment waiting times. If a prospective consumer was to review the Availability analysis of Dr. Willey over the three years data has been collected and analyzed by the program 110, they would not appreciate the dramatic improvement which has taken place over the past three months. If, on the other hand, trending analysis generated by the program 110 was used to highlight recent changes, this improvement would become recognizable and likely influence prospective consumers' provider selection.

The presentation of trending can be customized using the program 110, in accordance with how each individual end-user displays and reviews search analytics. In addition, providers could use trending analysis in their marketing efforts to highlight recent performance improvements.

Another important application of the invention is the ability of the program 110 to create customizable feedback, alerts, and prompts to consumers. These prompts can take a number of forms and can be the direct result of prior searches instituted by the individual consumer or changes in data of direct relevance to an individual consumer. An example of an automated prompt by the program 110, related to a prior search could be as simple as a change in a provider's availability after a scheduled appointment. A patient may have an appointment at a physician's office for 2:00 pm for Thursday. On Tuesday, the patient receives an automated prompt from the program 110, which alerts them to the fact that the physician has had a change in his work schedule placing him on call the preceding (Wednesday) evening. While the scheduled appointment is still for 2:00 pm on Thursday, the historical analysis (under the category of Operational Efficiency) of patient waiting times after an “on call” night increases from 12 minutes to 46 minutes. The patient is them presented with an option by the program 110, to “Reschedule” or “Keep Appointment”.

An example of a targeted alert by the program 110, based upon the individual consumer profile can be seen with a patient receiving a certain medication. In this example, Mr. Binder is receiving treatment for hypertension, and has been recently switched to a newly approved anti-hypertensive drug. A recently issued Food and Drug Administration (FDA) warning has been issued on the drug, alerting physicians and consumers about an increased incidence of liver disease associated with the drug. As a result, the Safety performance measures of the drug have been adversely affected (but only noticeable when reviewing trending analysis over the past four months). The program 110 identifies all physicians and patients currently prescribing or taking this drug and automatically sends them an alert of the FDA warning and Safety trending analysis via electronic means (i.e., text, email, etc.). The program 110 also provides each patient and physician with an option to schedule a “Laboratory: Liver Enzyme Profile” test immediately. This illustrates how the program 110 can be used to both educate consumers and also take proactive action, based upon changes in the performance data. While the present invention is primarily intended as a clinical empowerment tool, the vast array of standardized data and derived analytics by the program 110 provides a rich opportunity to perform medical research on Quality, Clinical Outcomes, Safety, and Economics. This research can take into account a multitude of variables relating to the individual service provider and consumer and identify interaction effects. The fact that the data is standardized and reproducible over multiple clinical practice and technology platforms provides an effective means of meta-analysis and large sample statistical analysis.

In addition to providing for rich research, this data generated by the program 110 can also be used to identify those service providers and consumers with the highest measures of clinical outcomes (Quality), and use this information to establish “best practice” Evidence-based Medicine guidelines.

Another unique application of the present invention is the creation of consumer networks, which can be created by the ability of the program 110 to use data within the individual profiles (as noted above). Individual consumers sharing key attributes can have the option of joining these groups which can serve a number of functions including support, education, and data collection. Participating consumers can share knowledge and experience with one another to assist in the selection of service providers.

It should be emphasized that the above-described embodiments of the invention are merely possible examples of implementations set forth for a clear understanding of the principles of the invention. Variations and modifications may be made to the above-described embodiments of the invention without departing from the spirit and principles of the invention. All such modifications and variations are intended to be included herein within the scope of the invention and protected by the following claims.

What is claimed is:

1. A computer-implemented method of instituting a series of standardized objective metrics for comparative analysis of medical services and products, comprising:
displaying on a display of a computer system, a plurality of input modes for user selection;
receiving the user selection and displaying options for searching a database of aid computer system, for medical services and products;
displaying options for said user in a customized manner, according to an identity of said user;
displaying a list of primary and secondary services to said user;
receiving a selection by said user of at least one of said primary or secondary services;
searching said database for a list of matching primary and secondary services based upon said selection and displaying results of said searching;
providing confirmations to said user of a selection of at least one of said matching primary and secondary services;
forwarding a survey to said user; and
forwarding completed results of said user's user of said medical services and products to said service providers.

2. The method of claim 1, wherein said input modes are manual or automatic.

3. The method of claim 1, wherein said primary and secondary services options are displayed separately.

4. The method of claim 1, wherein said primary and secondary services options are prioritized in display to said user.

5. The method of claim 1, wherein said user is notified of any changes to said user selection of primary or secondary services.

6. A computer system which institutes a series of standardized objective metrics for comparative analysis of medical services and products, comprising:
at least one memory which contains at least one program comprising the steps of:
displaying on a display of a computer system, a plurality of input modes for user selection;
receiving the user selection and displaying options for searching a database of aid computer system, for medical services and products;
displaying options for said user in a customized manner, according to an identity of said user;
displaying a list of primary and secondary services to said user;
receiving a selection by said user of at least one of said primary or secondary services;
searching said database for a list of matching primary and secondary services based upon said selection and displaying results of said searching;
providing confirmations to said user of a selection of at least one of said matching primary and secondary services;
forwarding a survey to said user; and
forwarding completed results of said user's user of said medical services and products to said service providers; and
a processor which executes the program.

7. A non-transitory computer readable medium whose contents cause a computer system to execute instructions of a program, the program comprising the steps of:
displaying on a display of a computer system, a plurality of input modes for user selection;
receiving the user selection and displaying options for searching a database of aid computer system, for medical services and products;
displaying options for said user in a customized manner, according to an identity of said user;
displaying a list of primary and secondary services to said user;
receiving a selection by said user of at least one of said primary or secondary services;
searching said database for a list of matching primary and secondary services based upon said selection and displaying results of said searching;
providing confirmations to said user of a selection of at least one of said matching primary and secondary services;
forwarding a survey to said user; and
forwarding completed results of said user's user of said medical services and products to said service providers.
